(19) United States
(12) Patent Application Publication
(10) Pub. No.: US 2010/0104010 A1
(43) Pub. Date: Apr. 29, 2010

(54) REAL-TIME RATE-CONTROL METHOD FOR VIDEO ENCODER CHIP

(76) Inventors: Jiun-In GUO, Minsyong Township (TW); Ping-Tsung Wu, Magong City (TW); Tzu-Chun Chang, Taipei City (TW); Ching-Lung Su, Douliou City (TW)

Correspondence Address: SINORICA, LLC, 2275 Research Blvd., Suite 500, ROCKVILLE, MD, 20850, US

(21) Appl. No.: 12/494,113

(22) Filed: Jun. 29, 2009

(30) Foreign Application Priority Data
Oct. 24, 2008 (TW) 97140973

(51) Int. Cl. H04N 7/26

(52) U.S. Cl. 375/240.12; 375/E07.243

(57) ABSTRACT

The present invention discloses a real-time rate-control method for a video encoder chip, wherein a BU-based RC algorithm is realized in a pipeline architecture, and wherein the RC algorithm is divided into an UpdateQP part arranged before the IME stage and an UpdateModel part arranged behind the entropy stage. When a currently processed frame contains a plurality of macro blocks, the bits used by several leading macro blocks and the remaining bits are predicted. Only the average value of the MADs of the preceding frame is stored in the memory. Thereby, memory consumption is greatly reduced, and quantization parameters are obtained to predict the bit number required by the next frame. The present invention further defines a region of interest and automatically regulates the bit distribution ratio thereof to enhance the sharpness thereof.

### BACKGROUND OF THE INVENTION

1. Field of the Invention

The present invention relates to a rate-control technology for a video encoder system, particularly to a real-time rate-control method for a video encoder chip.

2. Description of the Related Art

In the digital age, there are various digital video products appearing in daily living, including digital cameras, digital camcorders, digital monitor systems, and webcams. There are also many people enjoying sharing their lives with others in real time. Thus, some digital video Internet protocols (IP) are developed to satisfy the requirement.

H.264 is a high-compression digital video codec standard jointly developed by ITU-T VCEG and AVC MPEG of ISO/IEC 14496-10. H.264 features a high compression rate, high error-resistance and high bandwidth adaptability and is thus very suitable to apply to video streaming. No matter whether the video streaming is in a wired or wireless network, it is limited by the existing bandwidth and the buffer capacity. Therefore, it is very important to use an appropriate rate-control mechanism to control the data quantity of the encoded bit stream. Generally, a rate-control algorithm predicts the data quantity required by the next frame according to the information and complexity of the preceding frame and the current frame. Then, the rate-control algorithm varies the quantization parameters (QP) to control the bit number of each frame. The conventional rate-control technologies and algorithms are all software solutions and verified by software only. If the conventional rate-control (RC) algorithms are intended to be realized with hardware, the required memory capacity and the computational complexity will be too high to commercialize the products using the conventional RC algorithms. Distinct from the conventional technologies, the present invention proposes a novel technology to effectively reduce memory consumption and greatly decrease computational complexity in a rate-control process. The present invention further proposes a hardware architecture to realize the RC algorithm provided by the present invention and thereby makes a great step in the hardware realization of the digital video IP.

The RC algorithms serving H.264/AVC may be categorized into the frame-based RC algorithms and the BU (Basic Unit)-based RC algorithms. The frame-based RC algorithms can be realized in an MB (Macro Block) pipeline architecture. However, the macro blocks have huge difference in their data quantities. Thus, the frame-based RC algorithms predict the data quantities of the macro blocks less accurately than the BU-based RC algorithms. Nevertheless, the BU-based RC algorithms have a big shortcoming—it is hard to realize in a pipeline architecture. In the BU-based RC algorithms, many types of information are not generated until several states have passed. Therefore, the BU-based RC algorithms are very hard to realize in an MB pipeline architecture.

The reason why the BU-based RC algorithms cannot be realized in a pipeline architecture is that calculating the quantization parameter of the next basic unit cannot start until the compression of the current basic unit has been completed. For the same reason, the encoder system thus can take into consideration the data quantity configuration of the entire sequence and the optimization of the image quality when determining the quantization parameter of each basic unit. The feature makes the BU-based RC algorithms have a better video compression quality of the entire sequence. However, the feature is also a lethal drawback: it is impossible to calculate the quantization parameter of the next basic unit unless the final bit number of the currently compressed basic unit is obtained. Such a phenomenon is called data dependency. It is exactly because of data dependency that the conventional BU-based RC algorithms are impossible to realize in a pipeline hardware architecture. So far, none of the papers about the H.264 RC algorithms has proposed a solution for such a problem.

Refer to FIG. 1 for the hardware scheduling of a 4-stage pipeline encoder in a conventional technology. In Cycle 2, the moment the IME (Integer Motion Estimation) stage of the second MB begins, the QP, which the RC algorithm works out from the data of the first MB, is still at the FME (Fractional Motion Estimation) stage. At the same time, the QP, which should be generated by the second MB and is required by the third MB, has not been created yet. In such a 4-stage pipeline hardware architecture, the first problem to overcome is how to use the currently available data to correctly predict the data quantity of the corresponding MB and generate QP, whereby the performance of the video streaming of an encoder can meet the requirement of users.

Accordingly, the present invention proposes a real-time rate-control method for a video encoder chip to overcome the abovementioned problems.

### SUMMARY OF THE INVENTION

The primary objective of the present invention is to provide a real-time rate-control method for a video encoder chip, which calculates the remaining bits to predict the bit number required by the following macro block.

Another objective of the present invention is to provide a real-time rate-control method for a video encoder chip, wherein the mean absolute differences of the preceding frame are replaced by the average value thereof, whereby the used bit number can be predicted more accurately and then used to calculate the remaining bit number more precisely. A further objective of the present invention is to provide a real-time rate-control method for a video encoder chip, which defines a region of interest and automatically regulates the bit distribution ratio thereof to enhance the sharpness thereof.

To achieve the abovementioned objectives, the present invention proposes a real-time rate-control method for a video encoder chip, which applies to a macro block level video-streaming rate-control, and which comprises steps: entering a frame containing a plurality of macro blocks; assigning a preset quantization parameter to several leading macro blocks; predicting a bit number of at least one of several leading macro blocks, and calculating a mean absolute difference (MAD) of the macro block, and using the MAD as a first coefficient to correct the bit number; predicting a current bit number required by bone current macro block; and subtracting the bit numbers of all macro blocks in front of the current macro block from the current bit number to obtain a remaining bit number and evaluate the complexity of the frame and a bit number that should be distributed to a current frame, and then predicting data quantity of a next frame.

Below, the embodiments are described in detail to make easily understood the objectives, technical contents, characteristics and accomplishments of the present invention.

### BRIEF DESCRIPTION OF THE DRAWINGS

FIG. 1 is a diagram schematically showing the hardware scheduling of a 4-stage pipeline encoder in a conventional technology;

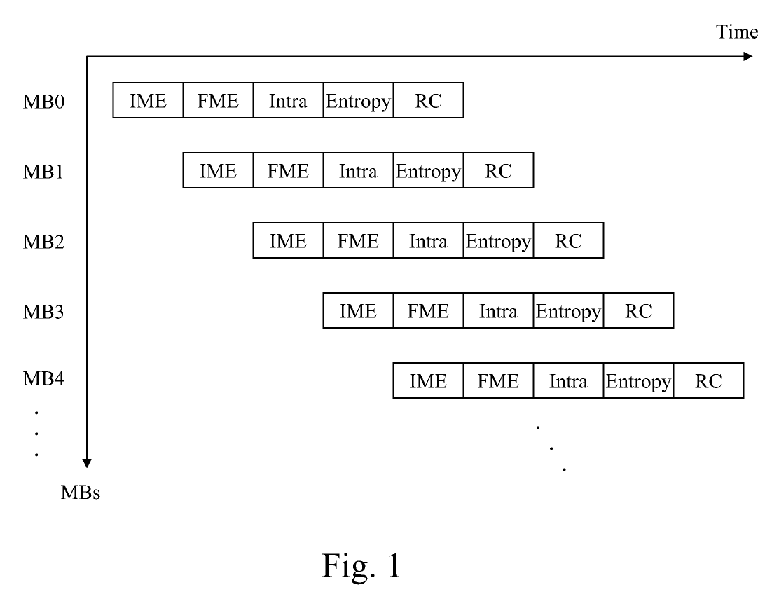

FIG. 2 is a diagram schematically showing the hardware scheduling of a 4-stage pipeline encoder according to one embodiment of the present invention; and

FIG. 3 is a block diagram of a hardware architecture serving the RC algorithm according to one embodiment of the present invention.

### DETAILED DESCRIPTION OF THE INVENTION

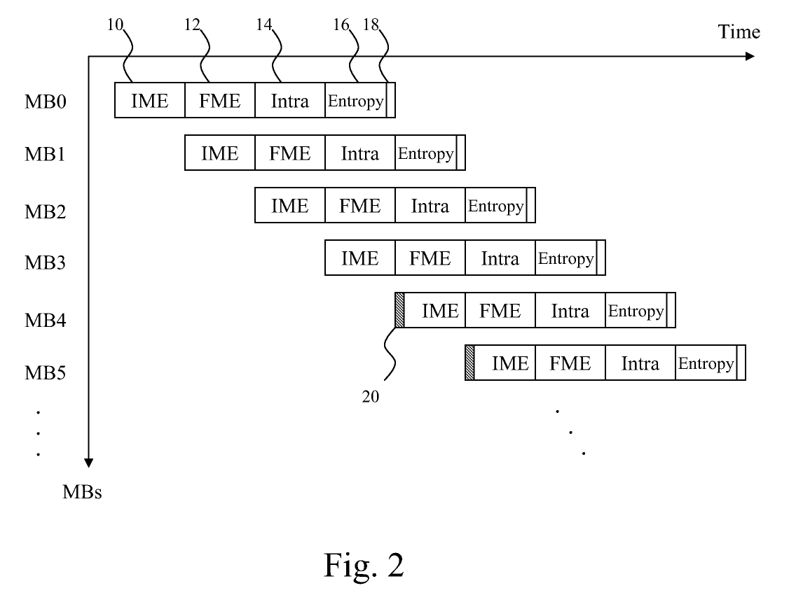

The present invention proposes a real-time rate-control method for a video encoder chip, which applies to a 4-stage (or more) pipeline architecture. In the embodiment applying to a 4-stage pipeline architecture, each frame contains a plurality of macro blocks (MB). Refer to FIG. 2. Each MB has four stages: an IME (integer motion estimation) stage 10, an FME (fractional motion estimation) stage 12, an Intra stage 14, and an Entropy stage 16.

In the present invention, the conventional RC algorithm is divided into an UpdateQP part 20 and an UpdateModel part 18; the UpdateQP part 20 is arranged before the IME stage 10, and the UpdateModel part 18 is arranged behind the Entropy stage 16. In the UpdateQP part 20, calculating QP needs the information of the remaining bits. However, the exact number of the bits used by the first macro block (MB0) is unknown until the four stages thereof are completed. In this embodiment, the bits used by MB0 is finally obtained by the UpdateQP part 20 of MB4. Therefore, the present invention predetermines that the QPs required by the front four macro blocks adopt the values assigned by the user, as shown in Equation (1):

if (MB_Number<4)

Qp=Initial_QP (1)

After the first macro block (MB0) has output data, such as curbuMAD, curbuHeaderBits and curbuTextureBits, the data may be used to predict the fifth macro block (MB4). When the data of MB0 is used to predict MB4, the value of the remaining bits is incorrect because three macro blocks are interposed between them. Therefore, the bit numbers of the three intermediate macro blocks must be estimated before adjusting the value of the remaining bits, whereby the values of the distributable bits can be more accurately estimated, as shown in Equation (2):

T_{r,l}=Tᵣ₁₋₄−[(m_{hdr,1-4}+m_{tex,1-4})×3×MADᵣₐₜᵢₒ₁] (2)

wherein T denotes the number of bits, r denotes the remaining bits, 1 denotes the ordinal number of the macro block, m denotes the number of the bits really generated, hdr denotes the header file, tex denotes texture, and MADᵣₐₜᵢₒ₁ denotes a first coefficient. Equation (2) can predict the value of the remaining bits. The number of the remaining bits of the current macro block is equal to the number of the remaining bits of the fourth macro block before the current macro block minus triple the number of the bits really used by the fourth macro block before the current macro block. If the triple the number of the bits really used by the fourth macro block before the current macro block is multiplied by the first coefficient, the prediction will be more accurate. The calculation of the first coefficient is expressed by Equation (3):

MADᵣₐₜᵢₒ₁=MAD_{PBUact}/MAD_{Pd} (3)

wherein MAD_{PBUact} is the real MAD (Mean Absolute Difference) of the preceding macro block, i.e. the MAD of the fourth macro block before the current macro block; MAD_{Pd} is the MAD of the current macro block. MAD is an index to verify whether the predicted value is correct in video encoding. The greater MAD, the less accurate the predicted value; it implies that the images move faster currently. Thus, MAD can be used to correct the predicted number of the remaining bits. The larger the MAD value, the more bits the three intermediate macro blocks require; the smaller the MAD value, the fewer bits the three intermediate macro blocks require. The calculation of MAD_{Pd} is expressed by Equation (4):

MAD_{Pd}=C₁×MAD_{PFAVG}×MADᵣₐₜᵢₒ₂+C₂ (4)

wherein C₁ and C₂ are parameters defined by the RC algorithm for the H.264/AVC and obtained from the UpdateModel part 18, and wherein MAD_{PFAVG} is the average value of all the MADs of the preceding frame, and MADᵣₐₜᵢₒ₂ is a second coefficient used to correct the MADs of the preceding and current macro blocks. In the H.264/AVC RC algorithm, the prediction of MAD_{PFAVG} is based on the MAD of the same address in the preceding frame, and then MAD_{PFAVG} is used to predict the MAD of the current frame according to a linear relationship. When such an approach is realized in hardware, the device has to store the MAD data of all the macro blocks; for a QCIF size picture, the device has to store 99 pieces of MAD data; for a DI size picture, the device has to store as many as 1350 pieces of MAD data. Therefore, the present invention uses MAD_{PFAVG} expressed by Equation (5) to save memory space, decrease data access activities, and reduce power consumption.

$$M A {D}_{PFAVG} = \frac{( {\sum }_{i = 1}^{{N}_{unit}} M A {D}_{i} )}{{N}_{unit}} \qquad ( 5 )$$

If MAD_{PFAVG} replaces the MAD of the same address in the preceding frame, the linear relationship in the H.264/AVC RC algorithm will not be acquired, and MAD prediction will be inaccurate. Further, the estimation of the bits that should be distributed will be incorrect, and QP prediction will fail. Thus, the required bits cannot be transmitted via the network, and the image will be incomplete. Therefore, the present invention uses the second coefficient MADᵣₐₜᵢₒ₂ to correct the MAD predictions of the preceding and current macro blocks. The calculation of the second coefficient is expressed by Equation (6):

MADᵣₐₜᵢₒ₂=MAD_{PFAVG}/MAD_{PBUact} (6)

Thereby, the remaining bits can be predicted according to the abovementioned equations. Then, the bits required by the current macro block can be predicted with Equation (7) of the H.264/AVC RC algorithm:

$${\tilde{b}}_{l} = {T}_{r} \times \frac{{\tilde{σ}}_{l , i}^{2} ( l )}{{\sum }_{k = l}^{{N}_{unit}} {\tilde{σ}}_{k , i}^{2} ( j )} \qquad ( 7 )$$

wherein \tilde{σ} denotes MAD, and \tilde{σ}_{l,i}(l) denotes the MAD of the lth MB of the ith frame. MAD is an index to predict complexity in the RC algorithm. The bit number of the current macro block is equal to the predicted MAD of the current macro block divided by the sum of the MADs of all the other macro blocks and then multiplied by the value of the remaining bits. In other words, the bits are distributed according to the ratio of the complexity of the current macro block to the complexity of the remaining macro blocks.

When the RC algorithm predicts the bit number required by the current macro block, it has to calculate \tilde{σ}_{k,i}(j)Nᵤₙᵢₜ−1 times. In other words, the RC algorithm has to perform the calculation of \tilde{σ}_{k,i}(j)(Nᵤₙᵢₜ−1)+1/2×(Nᵤₙᵢₜ−1) times for a frame. For a 4-stage pipeline hardware architecture, the cycles used by the above-mentioned calculations are much more than those used by the other stages, Thus, the other hardware structure will suspend, and the optimization of hardware yield is hard to achieve.

Therefore, the present invention proposes an equation to estimate the bits required by a macro block to enable the new algorithm to effectively operate in a 4-stage pipeline hardware architecture, and the equation is expressed by

$${\tilde{b}}_{l} = {T}_{r} \times ( \frac{M A {D}_{{Pd}_{i}}^{2}}{M A {D}_{PFAVG}^{2} \times NumofBU} ) \times M A {D}_{ratio 1} \qquad ( 8 )$$

wherein NumofBU denotes the number of the uncoded macro blocks. The present invention uses MAD_{PFAVG}²×NumofBU to replace the repeated MAD calculations to estimate the ratio of the current MB complexity to the total complexity. Herein, the first coefficient is used to increase the accuracy of Equation (8).

The new technology described above can integrate with a portion of the H.264/AVC RC algorithm to form a new algorithm, which can reduce computational complexity, save memory space and effectively operate in a 4-stage pipeline hardware architecture.

From the abovementioned equations, it is known that the RC algorithm needs a complicated calculation process. When the RC algorithm is realized in a 4-stage pipeline encoder, the calculation for a macro block needs 1000 cycles. In the present invention, the UpdateQP part 20 is arranged before the IME stage 10, and the UpdateModel part 18 is arranged behind the Entropy stage 16, as mentioned above. The UpdateQP part 20 should be completed within 120 cycles lest the efficiency of the other sages be affected. The UpdateModel part 18 should be completed within 300 cycles for the same reason. If directly realized in hardware under such a cyclic limitation, the algorithm needs a great number of calculations, and the hardware cost will be all spent on the same operation unit. Therefore, the present invention rearranges and integrates the abovementioned equations to share a common hardware and save the resource of the operation unit.

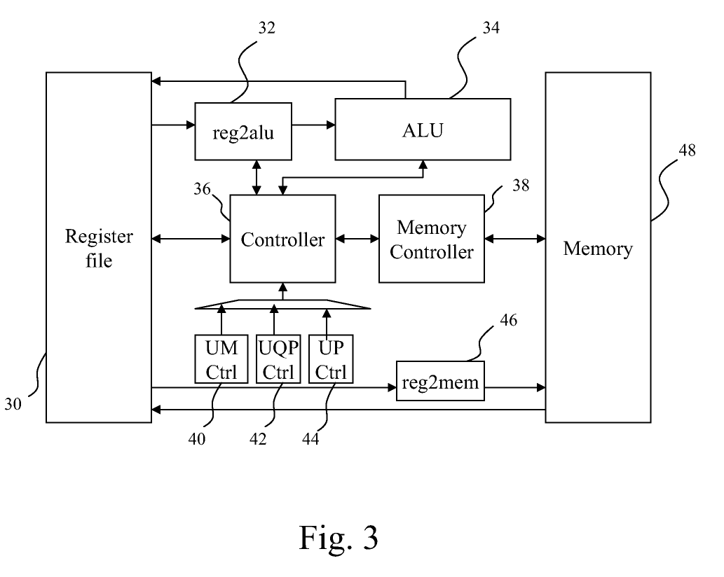

Refer to FIG. 3 for a hardware architecture serving the RC algorithm according to the present invention. The architecture comprises a register 30, a register-to-arithmetic and logic unit 32, an arithmetic and logic unit 34, a controller 36, a memory controller 38, and update model controller 40, an update quantization parameter controller 42, an update parameter 44, a register-to-memory unit 46, and a memory 48. In the present invention, the calculation of the equations for the UpdateQP part and UpdateModel part are all executed by the architecture, and the arithmetic and logic unit 34 plays an important role therein.

The arithmetic and logic unit 34 includes seven adders, two multipliers, a 16-cycle sequence divider, a 4-stage pipeline divider, a 16-cycle radical calculator, and a QP generator, whereby updating QP needs only 100 cycles, and updating models needs only 260 cycles. In other words, one macro block consumes only 360 cycles, and a QCIF-size frame consumes only 35640 cycles.

In the conventional architecture, if scheduled by the H.264/AVC RC algorithm, the calculation of Equation (7) for a QCIF-size frame will consume more hardware resources by 4185 cycles. Therefore, the architecture of the present invention can save the cycles by as high as 28% if the other conditions remain unchanged. Similarly, the architecture of the present invention can save the cycles by as high as 66% for a CIF-size frame, and save the cycles by as high as 87% for a D1-size frame.

Suppose that the MAD of each macro block is stored, and suppose that the storage of each piece of MAD needs 14 bits of memory space. Thus, one frame needs (Nᵤₙᵢₜ×14) bits of an external memory. Nevertheless, the present invention only memorizes the average value of the MADs of the total frame. Therefore, the present invention can greatly save memory resources. For example, the present invention can reduce the consumption of an external memory by 23.3% for a QCIF-size frame, by 55% for a CIF-size frame, and by as high as 80.6% for a D1-size frame.

To diversify the application, the present invention further proposes a method to make the picture sharper, wherein a region of interest (ROI) is demarcated from a picture, and the distribution ratios are automatically regulated to increase the bits for ROI according to Equation (9):

if(roi_factor [symbol] 0.3)

roi_total_bits=T*0.5*α

else if(roi_factor [symbol] 0.5)

roi_total_bits=T*0.6*α

else if(roi_factor [symbol] 0.7)

roi_total_bits=T*0.7*β

else if(roi_factor [symbol] 0.8)

roi_total_bits=T*0.8*β

else if(roi_factor [symbol] 0.9)

roi_total_bits=T*0.9*γ

else

roi_total_bits=T (9)

wherein T denotes the bits distributed to a frame, and “roi total bits” denotes the bits intended to be distributed to ROI, and α, β, γ are constants. The ratio of “roi total bits” is determined by a “roi factor”. The “roi factor” is calculated from Equation (10):

roi_factor:TotalMBsofROI/TotalNumberofBasicUnit (10)

wherein TotalMBsofROI is the number of the macro blocks inside ROI, and TotalNumberofBasicUnit is the number of the macro blocks inside the frame.

To further enhance the sharpness of ROI, the present invention also fine-tunes the acquired QP according to Equation (II):

if (MBatROIRegion==true)

finalQP=QP−QPminus

else

finalQP=QP+QPplus (11)

wherein QPminus and QPPlus are two regulation parameters. If the macro block being compressed is within ROI, QPminus is subtracted from the original QP to attain a better image quality. If the macro block being compressed is not within ROI, the original QP, QPPlus is added to the original QP. QPminus and QPPlus are calculated according to Equation (12):

$$Q P minus = ( \frac{( PAverageQP * TotalMBsofROI )}{( \frac{bitrate}{ω} )} ) * X 1 \\ Q P Plus = 1 * X 2 \qquad ( 12 )$$

wherein ω, X1, X2 are constants.

In conclusion, the present invention proposes a real-time rate-control method for a video encoder chip to improve the conventional rate-control algorithm, wherein the MAD values of all the macro blocks of the preceding frame is replaced by the average value thereof, whereby the remaining bits can be learned via accurately predicting the bits, and whereby the cycles used in calculations are decreased, and the memory consumption is reduced. The present invention also proposes a method to make sharper the image in ROI, wherein the distribution ratios are automatically regulated to increase the bits for ROI. Additionally, the present invention also fine-tunes the acquired QP to further enhance the sharpness of ROI. Thus, the present invention has advantages of low computational complexity and high video quality.

The embodiments described above are only to exemplify the present invention but not to limit the scope of the present invention. Therefore, any equivalent modification or variation according to the scope of the present invention is to be also included within the scope of the present invention.

What is claimed is:

1. A real-time rate-control method for a video encoder chip, which applies to a macro block level video-streaming rate-control, and which comprises steps:
entering a frame containing a plurality of macro blocks;
assigning a quantization parameter to several leading macro blocks in front of said macro blocks;
predicting a bit number of at least one of said several leading macro blocks, and calculating a mean absolute difference (MAD) of said macro block of said frame, and using said MAD as a first coefficient to correct said bit number;
predicting a current bit number of one current macro block of said macro blocks; and
subtracting said bit numbers of all said macro blocks in front of said current macro block from said current bit number to obtain a remaining bit number and evaluate a complexity of said frame and a bit number that should be distributed to a current frame and then predicting data quantity of a next frame.

2. The real-time rate-control method for a video encoder chip according to claim 1, wherein a number of said macro blocks is n; updating said quantization parameter of an m-th said macro block is based on an (m+n)-th said macro block.

3. The real-time rate-control method for a video encoder chip according to claim 1, wherein when said macro blocks have four stages, said several leading macro blocks are front four said macro blocks, and said bit numbers of a second macro block to a fourth macro block of said macro blocks are predicted.

4. The real-time rate-control method for a video encoder chip according to claim 3, wherein said bit number of a second macro block to a fourth macro block of said macro blocks is calculated according to an equation expressed by T_{r,l}=Tᵣ₁₋₄−[(m_{hdr,1-4}+m_{tex,1-4})×3×MADᵣₐₜᵢₒ₁], wherein Tᵣ denotes a bit number, 1 denotes an ordinal number of said macro block, m denotes number of bits really generated, hdr denotes a header file, tex denotes texture, and MADᵣₐₜᵢₒ₁ denotes said first coefficient.

5. The real-time rate-control method for a video encoder chip according to claim 4, wherein said first coefficient is calculated according to an equation expressed by MADᵣₐₜᵢₒ₁=MAD_{PBUact}/MAD_{Pd}, wherein MAD_{PBUact} is a real MAD of a preceding said macro block; MAD_{Pd} is a MAD of one currently-predicted said macro block.

6. The real-time rate-control method for a video encoder chip according to claim 1, wherein MAD of said current macro block is calculated according to an equation expressed by MAD_{Pd}=C₁×MAD_{PFAVG}×MADᵣₐₜᵢₒ₂+C₂, wherein C₁ and C₂ are two parameters; MAD_{PFAVG} is an average value of all MADs of a preceding frame; MADᵣₐₜᵢₒ₂ is a second coefficient used to correct MADs of preceding said macro blocks and said current macro block, and said second coefficient is calculated according to an equation expressed by MADᵣₐₜᵢₒ₂=MAD_{PFAVG}/MAD_{PBUact}.

7. The real-time rate-control method for a video encoder chip according to claim 1, wherein said current bit number of said current macro block is predicted according to an equation expressed by
$${\tilde{b}}_{l} = {T}_{r} \times ( \frac{M A {D}_{{Pd}_{i}}^{2}}{M A {D}_{PFAVG}^{2} \times NumofBU} ) \times M A {D}_{ratio 1}$$
wherein \tilde{b}ₗ is said current bit number of an l-th said macro block; NumofBU is number of uncoded said macro blocks; MAD_{Pd} is MAD of said current macro block; MAD_{PFAVG} is an average value of all MADs of a preceding frame; MADᵣₐₜᵢₒ₁ is said first coefficient.

8. The real-time rate-control method for a video encoder chip according to claim 1, wherein said macro blocks are arranged into a plurality of groups; each said macro block of one said group use a different parameter and a different said quantization parameter.

9. The real-time rate-control method for a video encoder chip according to claim 1, wherein said video encoder chip includes an arithmetic and logic unit, a register, a memory device, at least one controller, and a processor.

10. The real-time rate-control method for a video encoder chip according to claim 9, wherein said arithmetic and logic unit further comprises a plurality of adders, a plurality of multipliers, at least one divider, at least one radical calculator, and a quantization parameter.

11. The real-time rate-control method for a video encoder chip according to claim 10, wherein said arithmetic and logic unit has seven said adders.

12. The real-time rate-control method for a video encoder chip according to claim 10, wherein said arithmetic and logic unit has two said multipliers.

13. The real-time rate-control method for a video encoder chip according to claim 10, wherein said multipliers include a 16-cycle divider and a four-stage pipeline divider.

14. The real-time rate-control method for a video encoder chip according to claim 9, wherein said memory device includes a scratch pad memory and a memory.

15. The real-time rate-control method for a video encoder chip according to claim 1 further comprising steps to adjust sharpness of said frame:
selecting from said frame a region of interest; and
regulating a distribution ratio of said region of interest according to a size thereof to increase bits of said region of interest.

16. The real-time rate-control method for a video encoder chip according to claim 15, wherein distributing bits to said region of interest is based on total bits distributed to all said macro blocks of said frame.

17. The real-time rate-control method for a video encoder chip according to claim 15, wherein said distribution ratio is obtained via dividing number of said macro block of said region of interest by number of said macro blocks of said frame.
